(19) United States
(12) Patent Application Publication
(10) Pub. No.: US 2002/0056502 A1
(43) Pub. Date: May 16, 2002

(54) Textile laminate and articles made using the laminate

(75) Inventor: Yves A. Bordes, Paris (FR)

Correspondence Address: OSTROLENK FABER GERB & SOFFEN, 1180 AVENUE OF THE AMERICAS, NEW YORK, NY, 100368403

(73) Assignee: Textinov Ltd.

(21) Appl. No.: 09/749,024

(22) Filed: Dec. 26, 2000

(30) Foreign Application Priority Data
Sep. 25, 2000 (GB) 0023321.3

(51) Int. Cl. B32B 31/16

(52) U.S. Cl. 156/73.4; 156/289

(57) ABSTRACT

In order to make a laminate, a knitted terry-cloth elastic base fabric 42 is used, the fabric 42 having an elastic base made of synthetic yarn and a cotton pile. A film 28 of polyurethane resin is deposited on an anti-stick support web 16 and is set, and a layer 4 of polyurethane resin having adhesive properties is deposited on the film 28. The base fabric 42 is applied to the adhesive layer 40 whilst the latter is still liquid, after which the layer 40 is set. Finally, the film 28 is detached from the support web 16. The layers of polyurethane resin are impermeable to water and permeable to water vapor. Pieces of the laminate can be joined together by welding the respective film and adhesive to form a water tight join.

### BACKGROUND OF THE INVENTION

The present invention relates primarily to a process for making a composite sheet material or laminate useable as a fabric. The process comprises laminating a plastics film or skin to a base fabric.

The object of the invention is primarily that of providing a process which permits one to obtain a laminate which can be formed into three dimensional shapes and which is impermeable to water and permeable to water vapor.

It is also an object of the present invention to overcome or ameliorate at least one of the disadvantages of the prior art, or to provide a useful alternative.

### DESCRIPTION OF THE INVENTION

Broadly, a process for making a laminate comprising using a stretchable synthetic adhesive to laminate a stretchable synthetic film to a base fabric which is elastically stretchable in two directions at right angles in the plane of the base fabric, whereby the laminate is elastically stretchable in two directions at right angles in the plane of the laminate, the film and the layer of adhesive together being impermeable to water but permeable to water vapor, whereby the laminate is impermeable to water but permeable to water vapor. A process for making a made-up article comprising a plurality of joined-together pieces of the laminate comprising making joins between the pieces by welding the film and the adhesive of the respective pieces.

The elastic base fabric, together with the stretchable adhesive film (the latter can be called a skin), make the laminate elastically stretchable in two directions at right angles in the plane of the base fabric, for instance to adapt the laminate to the shape of the body in the case of a garment or to adapt it to the shape of a chair in the case of a cover; in the made-up article, the laminate will be stretchable in three directions at right angles. The base fabric, and the laminate, can preferably stretch by more than about 100%, though other minima are about 50% and about 30%. Nonetheless, the laminate is fully stabilized. By “elastic” is meant that on release of tension, the laminate returns substantially to its original unstretched configuration. The laminate can be washable. The laminate does not absorb water on the outside and is impermeable to water, but permeable to water vapour.

### The Base Fabric

The base fabric preferably has a pile on one side, preferably a closed-loop pile, e.g. a terry-cloth or the like. The laminate obtained in this way is fairly open so that it has an excellent permeability to air and to water vapor. The use of a closed-loop pile offers amongst others the advantage that the laminate can be used to make close-fitting clothing, for example tracksuits with the closed-loop pile in contact with the skin so as to act as a layer for absorbing sweat. Furthermore, the pile provides for a certain amount of air circulation within the base fabric whilst the air acts as a temperature barrier. Preferably, the base fabric is knitted and can be made on a circular knitting machine with multiple picks.

The base or support of the base fabric is elastic, and can be made of two types of yarn, one at least of which is elastic (the other may or may not be substantially inextensible). The yarns can be made of an inherently elastic material, or can be spun to provide elasticity. The preferred yarns are synthetic, such as a polyester for a first yarn and a resin such as nylon for a second, elastic yarn, but either or both the yarns could be natural. Preferably however, the yarns of the base fabric are fusible at the temperature of the welding referred to below; more generally, it is preferred that the base fabric comprises a yarn which is fusible at the welding temperature and a yarn that is not.

The yarn for the pile may be any natural yarn, though cotton is the preferred material—the yarn can be merely cotton-containing or contain more than about 73% cotton or be substantially pure cotton. If cotton is used for the pile, the base fabric may have in total about 82% cotton and about 18% resin, by weight. Nonetheless, other yarns such as wool, silk or linen are possible, as well any synthetic yarn which does not melt or become damaged at the temperature of the welding referred to below.

The preferred yarns are as follows:

Base:

twisted polyester yarn (picks with alternate S and Z twists); grade: 78 denier;

nylon elastic yarn called “Elasthane” or “Spandex” or “Lycra”; grade: 68 denier.

Pile:

combed unfinished blended cotton, two ends twisted 2/50 (1/50+1/50), metric.

Preferably the base of the base fabric has a weight in the untreated state of less than about 350 g/m², preferably less than about 295 g/m², lower weights being preferred. Preferably, the base fabric has a thickness less than about 0.4 mm, for instance of about 0.3 mm, and a pile height less than about 2.5 mm, preferably about 1.7 mm. If wool is used for the pile, the weight and thickness of the base fabric may be different.

Preliminary Treatment for Finishing the Base Fabric.

The unfinished base fabric, after being for instance cut length wise and opened up, can be subjected to various finishing treatments in a roller mill, such as blank sizing, amongst other things to make it anti-static, or to dyeing, followed by drying in a tumbler and then trimming.

The Film

The film is destined to form the outside layer of the laminate and is preferably formed of a polyurethane resin, normally with no plasticizer (softening ingredient), though for instance an acrylic resin may be used. The preferred polyurethane resins are as follows:

a) aliphatic monocomponent polyurethane;

b) aromatic or cyclic monocomponent polyurethane.

The resins (a) have excellent resistance to mechanical traction and light, but cannot resist alcohols.

The resins (b) have less resistance to mechanical stress, but resist both light and alcohols.

The film is preferably from about 15 to about 35 microns, or even up to about 60 microns, thick.

The Adhesive

The adhesive is preferably formed of a polyurethane resin, normally with no plasticizer, though for instance an acrylic resin could be used. The preferred polyurethane resins are multi-component resins, formed of two or more different polyester resins bound by cross-linking agents. The cross-linking agents preferably used for these resins have an isocyanic (aliphatic) or melamine (cyclic) or aromatic structure. The polyurethane resin adhesive, although providing a very firm anchorage to the base of the base fabric, does not pass through the fabric and does not alter the properties of the pile of the base fabric, which in this way maintains its softness and absorbing properties.

The adhesive layer is preferably from about 15 to about 35 microns thick, depending upon the proposed use of the laminate.

Film and Adhesive

The film and the adhesive may together have a thickness of the order of 50 microns, when the impermeability to water of the laminate can be greater than 1000 mm water pressure, measured according to ISO norm 811.

In order to make the laminate permeable to water vapour as well as being impermeable to water, transpiring hydrophilic polyurethanes can be used for both the film and the adhesive, that is having a molecular structure which, by its nature, absorbs water vapour, releasing it then to the external ambient. These may be in particular aliphatic polyurethanes.

The film or skin can be formed in any suitable way, for instance by extrusion, but in one process, it is formed by depositing a liquid layer of resin on a non-stick support and setting the resin.

The adhesive can be applied by depositing a liquid layer on the resin film, and the base fabric can be applied to the adhesive, the adhesive subsequently being set. However, as an alternative, the adhesive can first be applied to the base fabric, for instance with two or three coating rolls, and the resin film pressed onto the adhesive-coated fabric.

The thin synthetic layer and the adhesive are preferably transparent and colourless. In this way, the structure and colour and any printed decorations on the respective face of the base fabric remain clearly visible through the adhesive and the film. Thus the base fabric, particularly if it is for clothing or furniture covers, can be dyed or can be subjected to a decorative printing operation, in particular if the laminate is for clothing or covers. Alternatively however, it is possible to print on the outer film, or the film can be dyed or embossed, e.g. so that it looks like fur.

After the production of the laminate, the outer film can be activated, e.g. by being softened.

Use for Laminates

The laminates obtained according to the invention can be used, for example, for the following applications:

clothing, e.g. sports clothing, or protective clothing for instance for medical or paramedical use, or fashion garments;

coverings for vehicle seats;

hospital, hotel and similar “linen”;

gloves, stockings and socks;

cushion and pillow covers.

Making up Articles

The laminates are very suitable for morpho-cutting. If the made-up articles have a number of joined together pieces made of the inventive laminate, the laminate is excellent for making the joints between the various pieces by welding the polyurethane resin film or layer, for example by ultrasonic heat welding using so called sonotrodes. Such joins are waterproof and no subsequent waterproofing is required. Special block points (stronger joints) can be put in to prevent rupture of the joins under load. The joins of the made-up articles can be formed by fusing the film and the adhesive of the various pieces, but in a preferred arrangement, the base of the base fabric is also fused in order to form a very strong joint, though for instance the pile of the base fabric remaining unaffected; as indicated above, it is in general preferred that the base fabric comprises a yarn which is fusible at the welding temperature and a yarn that is not.

For protective clothing for instance, a stand-up seam can be used, but for garments, butt-type joins (edge-on-edge) can be formed. When butt-type joins are used, the made-up article can appear to be practically seamless. EP 0 790 888 A discloses a way of making the joins, though in connection with different materials.

### BRIEF DESCRIPTION OF THE DRAWINGS

The invention will be further described, by way of example, with reference to the accompanying drawings, in which:

FIG. 1 is an enlarged part section of a laminate, the thicknesses of the layers being greatly exaggerated for clarity and the correct proportions not being maintained;

FIG. 2 is a schematic elevation of a plant for the continuous fabrication of the laminate;

FIG. 3 corresponds to FIG. 2, but shows a modification;

FIG. 4a shows very schematically one way of joining two pieces of the laminate of the invention;

FIG. 4b shows the way of joining, somewhat less schematically;

FIG. 5 shows very schematically another way of joining two pieces of the laminate of the invention;

FIG. 6 is a front view of a garment made using the laminate of the invention;

FIG. 7 is the back view of the garment of FIG. 6; and

FIG. 8 is the side view of the garment of FIG. 6.

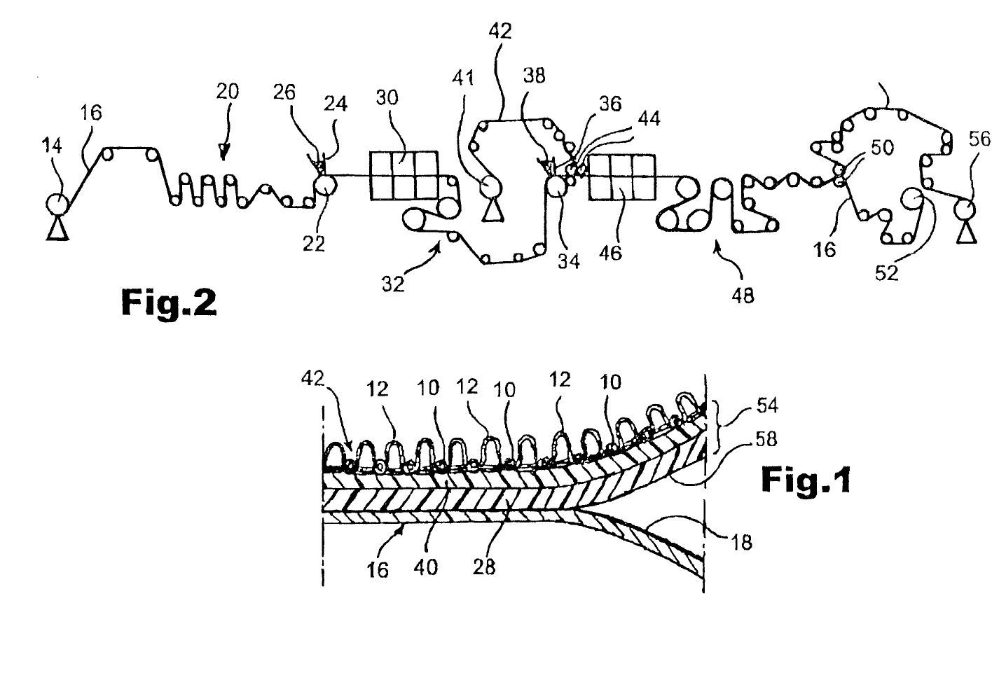

FIG. 1

The preferred base fabric 42 illustrated in FIG. 1 comprises a base or support 10 made of two types of yarn and a closed-loop pile 12 formed by a third type of yarn. FIG. 1 also illustrates the film and adhesive layer 54 consisting of the film 58 and the adhesive 40. FIG. 1 also shows a strip 16 on which the film 58 may be formed.

FIG. 2—One Method for Making the Laminate

In the following description, the smooth face of the base fabric is called “flat” and the pile face is called “reverse”.

Referring to FIG. 2, a continuous support web 16 (shown in FIG. 1) is drawn off a reel 14 and moves generally from left to right. The support 16 is preferably a web of strong paper whose upper surface 18 is provided with a release coating which is non-stick (anti-adhesive) in relation to polymerised polyurethane, for example a polypropylene or silicone coating.

The support 16 passes through a roller accumulator 20 and around a cylinder 22 of a coating machine. There is doctor blade 24 above the cylinder 22 which coats the upper face of the support 16 with a polyurethane resin 26 dissolved in a solvent. In this way, a first layer of resin 28 is applied to the support 16.

Following this, the support 16 with the first layer of resin 28 is passed through a tunnel oven 30 where the resin layer 28 is hardened, set or polymerised. The temperature inside the tunnel oven 30 is of the order of 150° C., that is above the evaporation temperature of the resin solvent, to allow hardening, setting or polymerisation of the resin itself. If the velocity of the support 16 is 15 m/min and the tunnel oven 30 has a length of 12 meters, the setting of one suitable resin is complete on exiting from the oven 30.

From the exit from the tunnel oven 30, the strip 16 with its first resin layer or film 28 passes through a roller accumulator 32 and then reaches a cylinder 34 forming part of a second coating device. This second coating device has a doctor blade 36 which applies to the first layer 28 a second layer 40 of a polyurethane resin 38 having adhesive properties dissolved in a solvent.

A web of base fabric 42 is unwound from a reel 41. The base fabric 42 passes between a pair of rolls 44 the downstream one of which applies the flat face of the base fabric 42 to the second layer 40 which is still liquid, the flat face being pressed on generally in the way indicated schematically in FIG. 1.

The multilayer web formed by the support 16 and the two resin layers 28 and 40 (of which the first layer 28 is set and the second layer 40 is still liquid) then passes through a second tunnel oven 46 which has the same dimensions and thermal characteristics as the tunnel oven 30, in which the solvent is evaporated and the second layer of resin 40 is hardened, set or polymerised.

At the exit of the tunnel oven 46, the second layer of resin 40 is completely set and firmly adhered to the first layer 28, while the meshes of the base 10 of the fabric 42 are firmly adhered to the second layer 40.

The composite strip exiting from the tunnel oven 46 then passes through a roller accumulator 48, after which this strip passes between a pair of rolls 50 at the exit of which the support 16 separates (see the right-hand part of FIG. 1) and is wound on a reel 52.

The composite sheet material or laminate 54, which consists of the polyurethane resin layers 28 and 40 and the base fabric 42, once detached from the support 16, is wound on a reel 56. No finishing is required. It is found that the second layer 40 engages the base fabric 42 at spaced points across the whole face of the base fabric 42.

As the non-stick surface 18 of the paper strip 16 is smooth (see FIG. 1), the visible face, referenced as 58 in FIG. 1, of the laminate 54 is also smooth.

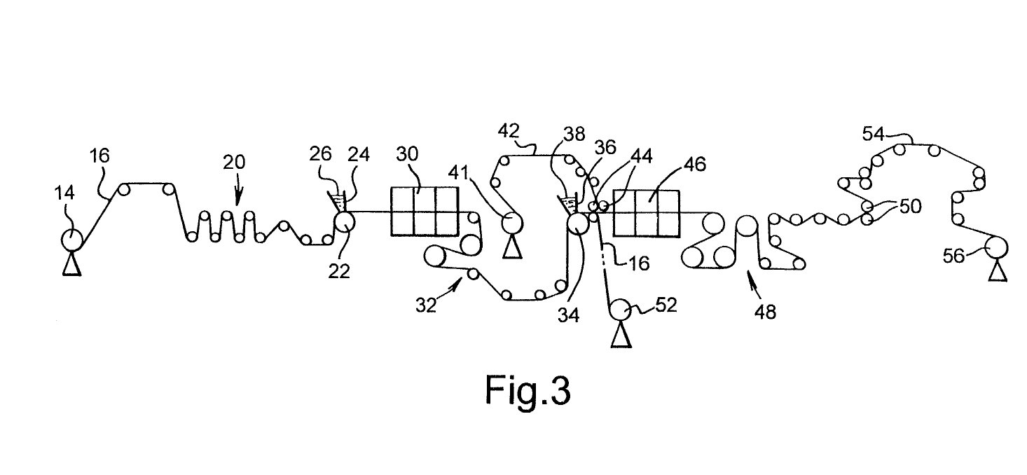

FIG. 3

FIG. 3 shows a small modification of the process of FIG. 1, in which the support 16 is removed from the resin layer 28 as soon as the resin layer 28 has set.

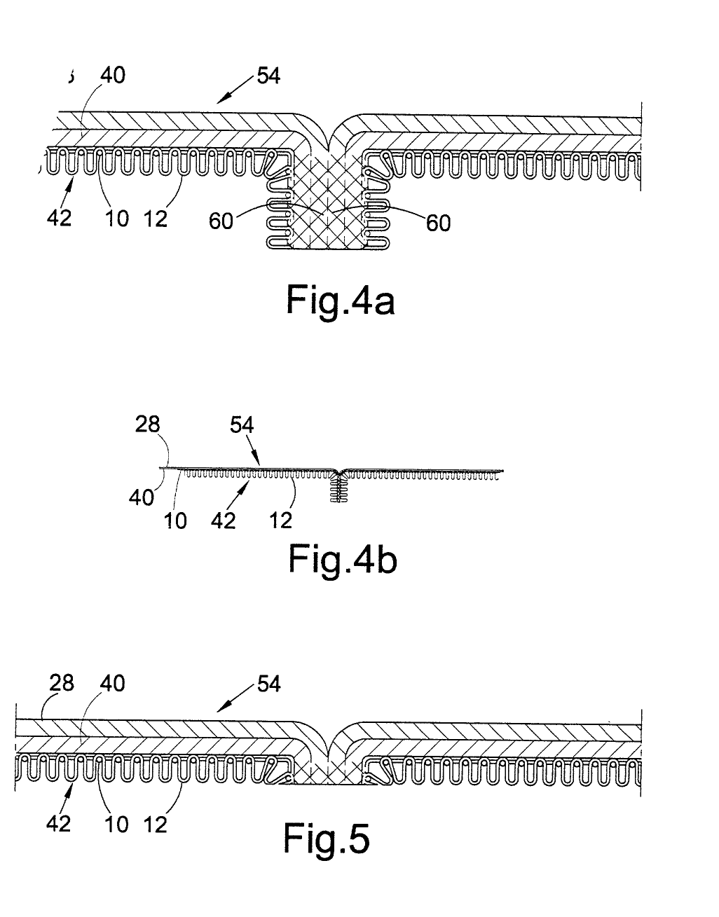

FIGS. 4a and 4b

FIG. 4a illustrates one way of joining together two pieces of the laminate 54, the proportions being as in FIG. 1 and very schematic. The proportions in FIG. 4b are not correct but are less exaggerated. The outer faces of the edge portions (raw edges) 60 are placed face-to-face and welded. If necessary, the weld temperature or duration can be such that all layers except the pile of the base fabric 42 melt and the fused plastic flows into the pile of the base fabric 42, providing a very strong join. Such joins can be used in protective garments where the presence of the upstanding seam is acceptable.

FIG. 5

FIG. 5 shows another way of forming the joins, the proportions being as in FIG. 1 and very schematic. In this case, the outer faces of the raw edges are brought face-to-face, but a combined ultrasonic welding and cutting procedure is used, for instance as disclosed in EP 0 790 888A, to weld together the outer film and the adhesive and in order to remove the upstanding seam. In this way, the join can be nearly flat and not readily visible, effectively a butt join, while providing sufficient strength.

As a combination of FIGS. 4a and 5, lock points can be provided in the joins of FIG. 5, i.e. short runs of joins where a seam as in FIG. 4a is left in place.

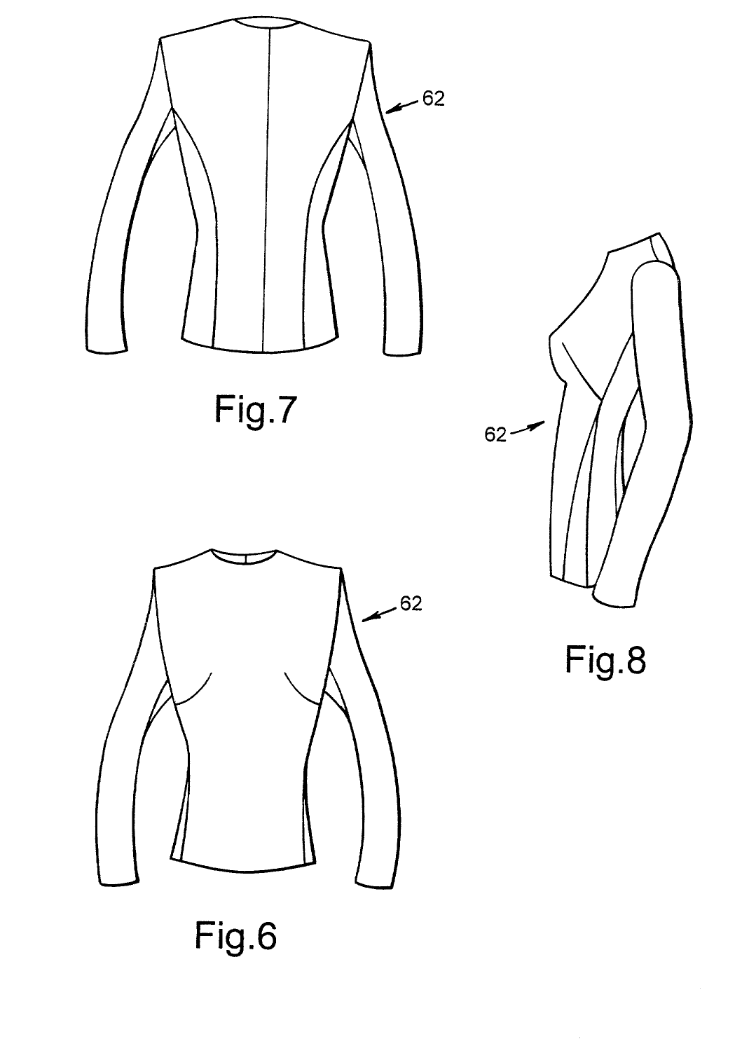

FIGS. 6 to 8

These Figures illustrate a garment 62. The lines within the outline of the garment indicate the joins.

### EXAMPLE

The Base Fabric

The base fabric was knitted on a circular knitting machine of 30 to 40 picks with a fineness of 18 flat needles per inch and providing a circular fabric of a nominal circumference of 200 cms. Due to the elasticity of the base of the fabric, the fabric shrinks to provide a flat double-thickness strip of a maximum width of 85 cms.

The knit of the base fabric made by the machine is set out by way of example in the following table, which has three columns, the left-hand one of which gives the number of the order of the picks, from 1 to 44, and the middle one of which gives the type of base yarn (PES=polyester, ELA=elastic), as well as the twist S or Z of the polyester, and the right-hand one of which gives the type of yarn of the closed loop pile and its grade (COT=cotton; grade: 1/50)).

| Pick | Base | Pile | Pick | Base | Pile |
|---|---|---|---|---|---|
| 1 | PES Z | COT 1/50 | 23 | PES S | COT 1/50 |
| 2 | ELA | COT 1/50 | 24 | ELA | COT 1/50 |
| 3 | PES S | COT 1/50 | 25 | PES Z | COT 1/50 |
| 4 | ELA | COT 1/50 | 26 | ELA | COT 1/50 |
| 5 | PES Z | COT 1/50 | 27 | PES S | COT 1/50 |
| 6 | ELA | COT 1/50 | 28 | ELA | COT 1/50 |
| 7 | PES S | COT 1/50 | 29 | PES Z | COT 1/50 |
| 8 | ELA | COT 1/50 | 30 | ELA | COT 1/50 |
| 9 | PES Z | COT 1/50 | 31 | PES S | COT 1/50 |
| 10 | ELA | COT 1/50 | 32 | ELA | COT 1/50 |
| 11 | PES S | COT 1/50 | 33 | PES Z | COT 1/50 |
| 12 | ELA | COT 1/50 | 34 | ELA | COT 1/50 |
| 13 | PES Z | COT 1/50 | 35 | PES S | COT 1/50 |
| 14 | ELA | COT 1/50 | 36 | ELA | COT 1/50 |
| 15 | PES S | COT 1/50 | 37 | PES Z | COT 1/50 |
| 16 | ELA | COT 1/50 | 38 | ELA | COT 1/50 |
| 17 | PES Z | COT 1/50 | 39 | PES S | COT 1/50 |
| 18 | ELA | COT 1/50 | 40 | ELA | COT 1/50 |
| 19 | PES S | COT 1/50 | 41 | PES Z | COT 1/50 |
| 20 | ELA | COT 1/50 | 42 | ELA | COT 1/50 |
| 21 | PES Z | COT 1/50 | 43 | PES S | COT 1/50 |
| 22 | ELA | COT 1/50 | 44 | ELA | COT 1/50 |

In this procedure, the machine was regulated in order to have the following lengths of yarn utilisation (LFA):

Base: 34 cms/100 needles;

Pile: 64.9 cms/100 needles.

The base fabric so knitted had the following characteristics:

thickness of base—about 0.3 mm;

height of pile—about 1.7 mm;

weight—about 295 g/m².

The Film

In the process of FIG. 2, a 30% by weight solution of a non-volatile monocomponent aliphatic polyurethane in alcohol (e.g. ethanol or propanol) and/or toluene or dimethyl formaldehyde was used.

A product of this type is available as “VITHANE XVP TR 7030”, from Rohm & Haas Company (30% solid polyurethane in 70% dimethyl formaldehyde, by weight). An alternative product is “VITHAREX” (a transpiring polyurethane resin), available from Morton.

The thickness of the set film was about 25 microns. The film weight was about 25 g/m².

The Adhesive

In the process of FIG. 2, the adhesive was a 45% by weight solution of a non-volatile bicomponent aliphatic polyurethane, containing melamine or isocyanate as a cross-linking agent, in an ethylacetate and methoxypropanol solvent or a dimethyl formaldehyde solvent. A product of this type is available as “VITHANE XVP TR 7050” from Rohm & Haas Company (45% solid polyurethane in 55% dimethyl formaldehyde, by weight). An alternative product is “VITHAREX”, as above.

The thickness of the set adhesive was about 25 microns with a weight of about 25 g/m². The coating on the base fabric had a final thickness of about 50 microns.

A laminate formed by a layer 28 of “VITHANE XVP TR 7030” and a layer 40 of “VITHANE XVP TR 7050” (the weight of the two layers being of the order of 60 g/m²) and by the closed-loop knitted fabric was subjected to a transpirability test, that is to say to test the resistance to the passage of water vapor. This test was carried out according to the norm DIN 54101, as defined by the Approved Standard B.P.I. 1.4 of the Hohenstein Institute (September 1987), which corresponds to International Standard Disclosure 11092. This test, called the “cup method”, enables one to quantify the sensation of comfort which one perceives when wearing a garment. The unit of measure of the test is called R.E.T. and is expressed in 10⁻³m²mbar/W. R.E.T. Values of less than 60 are considered very good. The laminate had an R.E.T. of 56, and very good transpirability. The laminate was also tested for water permeability. Its resistance to water penetration was 3000 mm of water column, measured according to norm ISO 811.

### X X X

Unless the context clearly requires otherwise, throughout the description and the claims, the words ‘comprise’, ‘comprising’, and the like, are to be construed in an inclusive as opposed to an exclusive or exhaustive sense; that is to say, in the sense of “including, but not limited to”.

The present invention has been described above purely by way of example, and modifications can be made within the spirit of the invention. The invention also consists in any individual features described or implicit herein or shown or implicit in the drawings or any combination of any such features or any generalization of any such features or combination.

What is claimed is:

1. A process for making a laminate, comprising laminating a stretchable synthetic film to a base fabric which is elastically stretchable in two directions at right angles in the plane of the base fabric using a stretchable synthetic adhesive, whereby the laminate is elastically stretchable in two directions at right angles in the plane of the laminate, the film and the layer of adhesive together being impermeable to water but permeable to water vapor, whereby the laminate is impermeable to water but permeable to water vapor.

2. The process according to claim 1, wherein the base fabric comprises a layer of two yarns, one of which is substantially inextensible and the other of which is elastic.

3. The process according to claim 3, wherein the substantially inextensible yarn comprises polyester and the elastic yarn comprises polyurethane.

4. The process according to claim 1, wherein the base fabric has a closed loop pile.

5. The process according to claim 4, wherein the base fabric has a closed loop pile formed by a thread different from the thread or threads of the base layer of the base fabric.

6. The process according to claim 4, wherein the thread of the pile of the base fabric is substantially pure cotton.

7. The process according to claim 1, wherein the base fabric is knitted.

8. The process according to claim 1, wherein the thickness of the film is between about 15 and about 35 microns.

9. The process of claim 1, wherein the film comprises polyurethane.

10. The process according to claim 1, wherein the thickness of the layer formed by the adhesive is between about 15 to about 35 microns.

11. The process according to claim 1, wherein the adhesive comprises polyurethane.

12. The process according to claim 1, wherein the adhesive comprises mixed polyester resins, bound by a cross-linking agent, without plasticizers.

13. The process according to claim 12, wherein the film comprises a bicomponent polyurethane.

14. The process according to claim 13, wherein a monocomponent aliphatic polyurethane is used as an about 30% by weight solution of a non-volatile monocomponent in order to form the film and a bicomponent aliphatic polyurethane is used as an about 45% by weight solution of bicomponents and melamine or isocyanate as a cross-linking agent.

15. The process according to claim 1, wherein the film and the adhesive comprise hydrophilic transpiring polyurethanes, thereby making the laminate substantially impermeable to water and permeable to water vapor.

16. The process according to claim 1, wherein the thickness of the film is substantially equal to the thickness of the adhesive layer.

17. The process according to claim 1, and comprising:
depositing on a non-stick support a first liquid layer of resin;
setting the first liquid layer;
depositing on the first layer a second layer of a liquid resin having adhesive properties;
applying the base fabric to the second liquid layer;
setting the second liquid layer; and
removing the substrate from the first layer of polymerized resin.

18. The process according to claim 17, carried out continuously, the support being in the form of a web and the base fabric being in the form of a web, the first layer of liquid resin being applied to the support which is then passed into a tunnel heater to evaporate solvent from the resin and set the first layer, the second layer of liquid resin being applied to the first layer of resin, and the base textile being applied to the second layer while the resin of the second layer is still liquid, after which the base fabric and the two layers of resin are passed through a second tunnel heater to evaporate the resin solvent and set the second layer.

19. The process according to claim 18, wherein said support comprises paper having a non-stick layer on its face which receives said first layer.

20. The process according to claim 1, wherein the adhesive is applied to one of the base fabric and the film and then the other of the base fabric and the film is pressed against said one of the base fabric and the film.

21. A process according to claim 1, further comprising making joins between a plurality of pieces the laminate by welding the film and the adhesive of the respective pieces, whereby a made-up article is realized.

22. The process according to claim 21, wherein the welding is ultrasonic.

23. The process of claim 21, wherein the joins are butt joins.

24. The process of claim 21, wherein edge zones of the pieces are placed face-to-face with the respective films in contact, the film and the adhesive of the respective pieces are melted, and substantially all of the edge zones are trimmed away.

25. The process of claim 21, wherein the welding is such that the base of the base fabric is not melted during welding.

26. The process of claim 21, wherein the composition of yarns forming the base fabric and the welding are such that at least one said yarn is melted during the welding and at least one said yarn is not.

27. A laminate made by the process of claim 1.

28. A made-up article comprising a plurality of laminates of claim 27 welded together.
